(19) United States
(12) Patent Application Publication
(10) Pub. No.: US 2024/0284960 A1
(43) Pub. Date: Aug. 29, 2024

(54) ARTICLES FOR USE WITH NON-COMBUSTIBLE AEROSOL PROVISION DEVICES

(71) Applicant: Nicoventures Trading Limited, London (GB)

(72) Inventors: Sydney TAVERN, London (GB); John RICHARDSON, London (GB)

(21) Appl. No.: 18/571,329

(22) PCT Filed: Jun. 17, 2022
(86) PCT No.: PCT/GB2022/051552

§ 371 Date: Dec. 18, 2023

(30) Foreign Application Priority Data
Jun. 18, 2021 (GB) 2108833.1

(51) Int. Cl. A24D 1/20; A24F 40/20; A24F 40/465; H05B 6/10

(52) U.S. Cl. CPC A24D 1/20; A24F 40/20; A24F 40/465; H05B 6/106

(57) ABSTRACT

An article for use with a non-combustible aerosol-provision device, the article including at least one fluid-permeable susceptor plug.

### RELATED APPLICATIONS

The present application is a National Phase entry of PCT Application No. PCT/GB2022/051552 filed Jun. 17, 2022, which claims priority to GB Application No. 2108833.1 filed Jun. 18, 2021, each is which is hereby incorporated by reference in their entirety.

### TECHNICAL FIELD

The present application relates to articles for use in non-combustible aerosol provision devices and to non-combustible aerosol provision systems comprising such articles and devices.

### BACKGROUND

Aerosol-generating systems produce an aerosol during use, which is inhaled by a user. For example, tobacco heating devices heat an aerosol-generating material such as tobacco to form an aerosol by heating, but not burning, the aerosol-generating material. Some aerosol-generating systems include a susceptor which is configured to heat the aerosol-generating material and form an aerosol.

### SUMMARY

According to a first aspect of the disclosure, there is provided an article for use with a non-combustible aerosol-provision device, the article comprising at least one fluid-permeable susceptor plug.

In some embodiments, the article is in the form of a rod having a distal end and a mouth end opposite to the distal end.

In some embodiments, the article comprises an aerosol-generating section comprising aerosol-generating material.

In some embodiments, the fluid permeable susceptor plug is adjacent the aerosol-generating material.

In some embodiments, the article comprises two or more aerosol-generating sections, each section comprising aerosol-generating material.

In some embodiments, the fluid permeable susceptor plug is adjacent at least two of the two or more sections.

In some embodiments, the sections of aerosol-generating material are separated by one or more susceptor plugs.

In some embodiments, the aerosol-generating section and the porous plug are circumscribed by a wrapper.

In some embodiments, the susceptor plug is arranged to allow passage of gas from an environment external to the article from the distal end to the mouth end and through the susceptor plug in use.

In some embodiments, the susceptor plug is positioned at the distal end of the rod such that, in use, air flows through the susceptor plug before contacting at least one of the one or more aerosol-generating materials.

In some embodiments, the susceptor plug is positioned in the aerosol-generating section such that, in use, air flows through at least one of the sections of aerosol-generating material before flowing through the susceptor plug.

In some embodiments, the article comprises a first section of aerosol-generating material and a second section of aerosol-generating material and the susceptor plug is positioned in the article such that, in use, the first section of aerosol-generating material generates an aerosol when heated which flows through the susceptor plug before flowing through the second section of aerosol-generating material.

In some embodiments, the susceptor plug has a cross-sectional shape substantially identical to a cross-sectional shape of one or more of the one or more aerosol-generating sections.

In some embodiments, the susceptor plug is porous.

In some embodiments, the susceptor plug comprises a material heatable by penetration with a varying magnetic field in an amount of up to 100 wt %.

In some embodiments, the material heatable by penetration with a varying magnetic field is a metal or a non-metal.

In some embodiments, the material heatable by penetration with a varying magnetic field is in the form of beads, flakes, particles, shards, rods, tubes or loops.

In some embodiments, the susceptor plug comprises a fibrous material.

In some embodiments, the susceptor plug comprises a material that is not heatable by penetration with a varying magnetic field.

In some embodiments, the material heatable by penetration with a varying magnetic field is at least partially embedded in the material that is not heatable by penetration with a varying magnetic field.

In some embodiments, the material not heatable by penetration with a varying magnetic field is selected from the group consisting of: ceramic, plastic, botanical material, glass and a mineral.

In some embodiments, the aerosol-generating material comprises botanical material.

In some embodiments, the aerosol-generating material comprises reconstituted tobacco and/or lamina tobacco.

According to a second aspect of the disclosure, there is provided a fluid-permeable susceptor plug for use in the article of the first aspect.

According to a third aspect of the disclosure, there is provided a device for use with the article of the first aspect.

According to a fourth aspect of the disclosure, there is provided a system comprising the article of the first aspect and a device of the third aspect.

According to a fifth aspect of the disclosure, there is provided a use of an article according to the first aspect with a non-combustible aerosol provision device to generate an aerosol.

### BRIEF DESCRIPTION OF THE DRAWINGS

Embodiments of the invention will now be described, by way of example only, with reference to the accompanying drawings, in which:

FIG. 1 is a perspective view of an article for use with a non-combustible aerosol provision device;

FIG. 2 is a side-on cross-sectional view of the article shown in FIG. 1;

FIG. 3a is an end-on cross-sectional view of part of the article shown in FIGS. 1 and 2; 3b is an end-on cross-sectional view of part of the article shown in FIGS. 1 and 2;

FIGS. 4a, 4b, 4c, 5, 6, 6a and 6b are side-on cross-sectional views of a part of components for articles for use with non-combustible aerosol provision devices; and

FIGS. 7 to 10 are schematic views of non-combustible aerosol provision devices.

### DETAILED DESCRIPTION

As used herein, the term “delivery system” is intended to encompass systems that deliver at least one substance to a user, and includes:

combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);

non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to articles comprising aerosol-generating material and configured to be used with non-combustible aerosol provision devices. These articles are sometimes referred to as consumables throughout the disclosure.

The terms ‘upstream’ and ‘downstream’ used herein are relative terms defined in relation to the direction of mainstream aerosol drawn through an article or device in use.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system comprises an area for receiving the article for use in the non-combustible aerosol-provision system, a housing, a mouthpiece, a filter and/or an aerosol-modifying agent.

In the figures described herein, like reference numerals are used to illustrate equivalent features, articles or components.

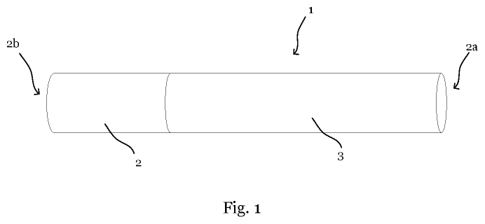

FIG. 1 is a perspective view of an article 1 for use in an aerosol delivery system.

The article 1 comprises a mouthpiece 2, and an aerosol-generating section 3, connected to the mouthpiece 2. In the present example, the aerosol-generating section 3 comprises a cylindrical rod of aerosol-generating composition. The article 1 comprises a downstream end 2b and an upstream end 2a distal from the downstream end 2b.

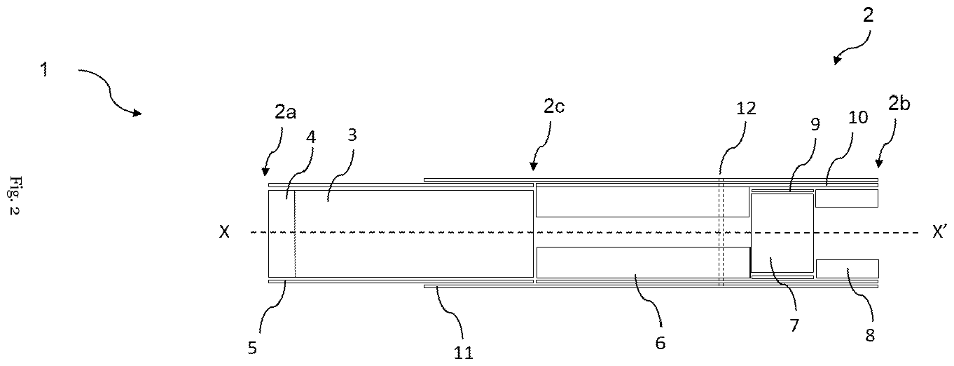

FIG. 2 is a side-on cross sectional view of the article 1.

The article 1 comprises a mouthpiece 2, and an aerosol-generating section 3, connected to the mouthpiece 2. Adjacent the aerosol-generating section 3 is a fluid permeable susceptor plug 4 in the form of a cylindrical rod. In the present example, the aerosol generating 3 section comprises a cylindrical rod of aerosol-generating material. The article 1 comprises an upstream end 2a and a downstream end 2b distal from the upstream end 2a.

In the present example, the cylindrical rod of aerosol-generating material comprises a plurality of strands and/or strips of aerosol-generating material, and is circumscribed by a wrapper 5. In the present example, the wrapper 5 is a moisture impermeable wrapper. The wrapper 5 also circumscribes the fluid permeable susceptor plug 4.

The plurality of strands or strips of aerosol-generating material may be aligned within the aerosol-generating section such that their longitudinal dimension is in parallel alignment with a longitudinal axis, X-X′ of the article 1. Alternatively, the strands or strips may generally be arranged such that their longitudinal dimension aligned is transverse to the longitudinal axis of the article.

At least about 10%, 20%, 30%, 40%, 50%, 60%, 70%, 80%, 90% or 95% of the plurality of strands or strips may be arranged such that their longitudinal dimension is in parallel alignment with the longitudinal axis of the article. A majority of the strands or strips may be arranged such that their longitudinal dimensions are in parallel alignment with the longitudinal axis of the article. In some embodiments, about 95% to about 100% of the plurality of strands or strips are arranged such that their longitudinal dimension is in parallel alignment with the longitudinal axis of the article. In some embodiments, substantially all of the strands or strips are arranged in the aerosol-generating section such that their longitudinal dimension is in parallel alignment with the longitudinal axis of the aerosol-generating section of the article.

The mouthpiece 2 includes a cooling section 6, also referred to as a cooling element, positioned immediately downstream of and adjacent to the source of aerosol-generating composition 3. In the present example, the cooling section 6 is in an abutting relationship with the source of aerosol-generating material. The mouthpiece 2 also includes, in the present example, a body of material 7 downstream of the cooling section 6, and a hollow tubular element 8 downstream of the body of material 7, at the mouth end of the article 1.

The cooling section 6 comprises a hollow channel, having an internal diameter of between about 1 mm and about 4 mm, for example between about 2 mm and about 4 mm. In the present example, the hollow channel has an internal diameter of about 3 mm. The hollow channel extends along the full length of the cooling section 6. In the present example, the cooling section 6 comprises a single hollow channel. In alternative embodiments, the cooling section can comprise multiple channels, for example, 2, 3 or 4 channels. In the present example, the single hollow channel is substantially cylindrical, although in alternative embodiments, other channel geometries/cross-sections may be used. The hollow channel can provide a space into which aerosol drawn into the cooling section 6 can expand and cool down. In all embodiments, the cooling section is configured to limit the cross-sectional area of the hollow channel/s, to limit tobacco displacement into the cooling section, in use.

The cooling section 6 preferably has a wall thickness in a radial direction, which can be measured, for example, using a calliper. The wall thickness of the cooling section 6, for a given outer diameter of cooling section, defines the internal diameter for the cavity surrounded by the walls of the cooling section 6. The cooling section 6 can have a wall thickness of at least about 1.5 mm and up to about 2 mm. In the present example, the cooling section 6 has a wall thickness of about 2 mm. Providing a cooling section 6 having a wall thickness within this range improves the retention of the source of aerosol-generating material in the aerosol generating section, in use, by reducing the longitudinal displacement of strands and/or strips of aerosol-generating material when the aerosol generator is inserted into the article.

The cooling section 6 is formed from filamentary tow. Other constructions can be used, such as a plurality of layers of paper which are parallel wound, with butted seams, to form the cooling section 6; or spirally wound layers of paper, cardboard tubes, tubes formed using a papier-mâché type process, molded or extruded plastic tubes or similar. The cooling section 6 is manufactured to have a rigidity that is sufficient to withstand the axial compressive forces and bending moments that might arise during manufacture and whilst the article 1 is in use.

The wall material of the cooling section 6 can be relatively non-porous, such that at least 90% of the aerosol generated by the aerosol generating material 3 passes longitudinally through the one or more hollow channels rather than through the wall material of the cooling section 6. For instance, at least 92% or at least 95% of the aerosol generated by the aerosol generating material 3 can pass longitudinally through the one or more hollow channels.

The filamentary tow forming the cooling section 6 preferably has a total denier of less than 45,000, more preferably less than 42,000. This total denier has been found to allow the formation of a cooling section 6 which is not too dense. Preferably, the total denier is at least 20,000, more preferably at least 25,000. In preferred embodiments, the filamentary tow forming the cooling section 6 has a total denier between 25,000 and 45,000, more preferably between 35,000 and 45,000. Preferably the cross-sectional shape of the filaments of tow are ‘Y’ shaped, although in other embodiments other shapes such as ‘X’ shaped filaments can be used.

The filamentary tow forming the cooling section 6 preferably has a denier per filament of greater than 3. This denier per filament has been found to allow the formation of a tubular element 6 which is not too dense. Preferably, the denier per filament is at least 4, more preferably at least 5. In preferred embodiments, the filamentary tow forming the hollow tubular element 6 has a denier per filament between 4 and 10, more preferably between 4 and 9. In one example, the filamentary tow forming the cooling section 6 has an Y40,000 tow formed from cellulose acetate and comprising 18% plasticiser, for instance triacetin.

Preferably, the density of the material forming the cooling section 6 is at least about 0.20 grams per cubic centimetre (g/cc), more preferably at least about 0.25 g/cc. Preferably, the density of the material forming the cooling section 6 is less than about 0.80 grams per cubic centimetre (g/cc), more preferably less than 0.6 g/cc. In some embodiments, the density of the material forming the cooling section 6 is between 0.20 and 0.8 g/cc, more preferably between 0.3 and 0.6 g/cc, or between 0.4 g/cc and 0.6 g/cc or about 0.5 g/cc. These densities have been found to provide a good balance between improved firmness afforded by denser material and minimising the overall weight of the article. For the purposes of the present invention, the “density” of the material forming the cooling section 6 refers to the density of any filamentary tow forming the element with any plasticiser incorporated. The density may be determined by dividing the total weight of the material forming the cooling section 6 by the total volume of the material forming the cooling section 6, wherein the total volume can be calculated using appropriate measurements of the material forming the cooling section 6 taken, for example, using callipers. Where necessary, the appropriate dimensions may be measured using a microscope.

Preferably, the length of the cooling section 6 is less than about 30 mm. More preferably, the length of the cooling section 6 is less than about 25 mm. Still more preferably, the length of the cooling section 6 is less than about 20 mm. In addition, or as an alternative, the length of the cooling section 6 is preferably at least about 10 mm. Preferably, the length of the cooling section 6 is at least about 15 mm. In some preferred embodiments, the length of the cooling section 6 is from about 15 mm to about 20 mm, more preferably from about 16 mm to about 19 mm. In the present example, the length of the cooling section 6 is 19 mm.

The cooling section 6 is located around and defines an air gap within the mouthpiece 2 which acts as a cooling section. The air gap provides a chamber through which heated volatilized components generated by the rod of aerosol-generating material 3 flow. The cooling section 6 is hollow to provide a chamber for aerosol accumulation yet rigid enough to withstand axial compressive forces and bending moments that might arise during manufacture and whilst the article 1 is in use. The cooling section 6 provides a physical displacement between the aerosol-generating material 3 and the body of material 7. The physical displacement provided by the cooling section 6 can provide a thermal gradient across the length of the cooling section 6.

Preferably, the mouthpiece 2 comprises a cavity having an internal volume greater than 110 mm³. Providing a cavity of at least this volume has been found to enable the formation of an improved aerosol. More preferably, the mouthpiece 2 comprises a cavity, for instance formed within the cooling section 6, having an internal volume greater than 110 mm³, and still more preferably greater than 130 mm³, allowing further improvement of the aerosol. In some examples, the internal cavity comprises a volume of between about 130 mm³ and about 230 mm³, for instance about 134 mm³ or 227 mm³.

The cooling section 6 can be configured to provide a temperature differential of at least 40 degrees Celsius between a heated volatilized component entering a first, upstream end of the cooling section 6 and a heated volatilized component exiting a second, downstream end of the cooling section 6. The cooling section 6 is preferably configured to provide a temperature differential of at least 60 degrees Celsius, preferably at least 80 degrees Celsius and more preferably at least 100 degrees Celsius between a heated volatilized component entering a first, upstream end of the cooling section 6 and a heated volatilized component exiting a second, downstream end of the cooling section 6. This temperature differential 7 the length of the cooling section 6 protects the temperature sensitive body of material 7 from the high temperatures of the aerosol-generating material 3 when it is heated.

When in use, the aerosol-generating section may exhibit a pressure drop of from about 15 to about 40 mm H₂O. In some embodiments, the aerosol-generating section exhibits a pressure drop across the aerosol-generating section of from about 15 to about 30 mm H₂O.

The aerosol-generating material may have a packing density of between about 400 mg/cm³ and about 900 mg/cm³ within the aerosol-generating section. A packing density higher than this may increase the pressure drop.

At least about 70% of a volume of the aerosol-generating section is filled with the aerosol-generating material. In some embodiments, from about 75% to about 85% of the volume of the cavity is filled with the aerosol-generating material.

A tipping paper 11 is wrapped around the full length of the mouthpiece 2 and over part of the rod of aerosol-generating material 3 and has an adhesive on its inner surface to connect the mouthpiece 2 and rod 3. In the present example, the rod of aerosol-generating material 3 is wrapped in wrapper 5, which forms a first wrapping material, and the tipping paper 11 forms an outer wrapping material which extends at least partially over the rod of aerosol-generating material 3 to connect the mouthpiece 2 and rod 3. In some examples, the tipping paper can extend only partially over the rod of aerosol-generating material.

In the present example, the tipping paper 11 extends 5 mm over the rod of aerosol-generating material 3 but it can alternatively extend between 3 mm and 10 mm over the rod 3, or more preferably between 4 mm and 6 mm, to provide a secure attachment between the mouthpiece 2 and rod 3. The tipping paper can have a basis weight greater than 20 gsm, for instance greater than 25 gsm, or preferably greater than 30 gsm, for example 37 gsm. These ranges of basis weights have been found to result in tipping papers having acceptable tensile strength while being flexible enough to wrap around the article 1 and adhere to itself along a longitudinal lap seam on the paper. The outer circumference of the tipping paper 11, once wrapped around the mouthpiece 2, is about 23 mm.

In the present embodiment, the moisture impermeable wrapper 5 which circumscribes the rod of aerosol-generating material comprises a paper wrapper. In other embodiments, the wrapper 5 comprises a aluminium foil, optionally comprising a barrier coating to make the material of the wrapper substantially moisture impermeable. Aluminium foil has been found to be particularly effective at enhancing the formation of aerosol within the aerosol-generating material 3. In the present example, the aluminium foil has a metal layer having a thickness of about 6 μm. In the present example, the aluminium foil has a paper backing. However, in alternative arrangements, the aluminium foil can be other thicknesses, for instance between 4 μm and 16 μm in thickness. The aluminium foil also need not have a paper backing, but could have a backing formed from other materials, for instance to help provide an appropriate tensile strength to the foil, or it could have no backing material.

Metallic layers or foils other than aluminium can also be used. The total thickness of the wrapper is preferably between 20 μm and 60 μm, more preferably between 30 μm and 50 μm, which can provide a wrapper having appropriate structural integrity and heat transfer characteristics. The tensile force which can be applied to the wrapper before it breaks can be greater than 3,000 grams force, for instance between 3,000 and 10,000 grams force or between 3,000 and 4,500 grams force. Where the wrapper comprises paper or a paper backing, i.e. a cellulose based material, the wrapper can have a basis weight greater than about 30 gsm. For example, the wrapper can have a basis weight in the range from about 40 gsm to about 70 gsm. Such basis weights provide an improved rigidity to the rod of aerosol-generating material. The improved rigidity provided by wrappers having a basis weight in this range can make the rod of aerosol-generating material 3 more resistant to crumpling or other deformation under the forces to which the article is subject, in use. Providing a rod of aerosol-generating material having increased rigidity can be beneficial where the plurality of strands or strips of aerosol-generating material are aligned within the aerosol-generating section such that their longitudinal dimension is in parallel alignment with the longitudinal axis, since longitudinally aligned strands or strips of aerosol-generating material may provide less rigidity to the rod of aerosol generating material than when the strands or strips are not aligned. The improved rigidity of the rod of aerosol-generating material allows the article to withstand the increased forces to which the article is subject, in use.

In the present example, the moisture impermeable wrapper 5 is also substantially impermeable to air. In alternative embodiments, the wrapper 5 preferably has a permeability of less than 100 Coresta Units, more preferably less than 60 Coresta Units. It has been found that low permeability wrappers, for instance having a permeability of less than 100 Coresta Units, more preferably less than 60 Coresta Units, result in an improvement in the aerosol formation in the aerosol-generating material 3. Without wishing to be bound by theory, it is hypothesized that this is due to reduced loss of aerosol compounds through the wrapper 5.

The permeability of the wrapper 5 can be measured in accordance with ISO 2965:2009 concerning the determination of air permeability for materials used as cigarette papers, filter plug wrap and filter joining paper.

The body of material 7 and hollow tubular element 8 each define a substantially cylindrical overall outer shape and share a common longitudinal axis. The body of material 7 is wrapped in a first plug wrap 9. Preferably, the first plug wrap 9 has a basis weight of less than 50 gsm, more preferably between about 20 gsm and 40 gsm. Preferably, the first plug wrap 9 has a thickness of between 30 μm and 60 μm, more preferably between 35 μm and 45 μm.

Preferably, the first plug wrap 9 is a non-porous plug wrap, for instance having a permeability of less than 100 Coresta units, for instance less than 50 Coresta units. However, in other embodiments, the first plug wrap 9 can be a porous plug wrap, for instance having a permeability of greater than 200 Coresta Units.

The article has a ventilation level of about 10% of the aerosol drawn through the article. In alternative embodiments, the article can have a ventilation level of between 1% and 20% of aerosol drawn through the article, for instance between 1% and 12%. Ventilation at these levels helps to increase the consistency of the aerosol inhaled by the user at the mouth end 2b, while assisting the aerosol cooling process. The ventilation is provided directly into the mouthpiece 2 of the article 1. In the present example, the ventilation is provided into the cooling section 6, which has been found to be particularly beneficial in assisting with the aerosol generation process. The ventilation is provided via perforations 12, in the present case formed as a single row of laser perforations, positioned 13 mm from the downstream, mouth-end 2b of the mouthpiece 2. In alternative embodiments, two or more rows of ventilation perforations may be provided. These perforations pass though the tipping paper 11, second plug wrap 10 and cooling section 6. In alternative embodiments, the ventilation can be provided into the mouthpiece at other locations, for instance into the body of material 7 or first tubular element 8. Preferably, the article is configured such that the perforations are provided about 28 mm or less from the upstream end of the article 1, preferably between 20 mm and 28 mm from the upstream end of the article 1. In the present example, the apertures are provided about 25 mm from the upstream end of the article.

The article 1 comprises a susceptor plug 4. The susceptor plug comprises or consists of susceptor material, which is a material capable of being inductively heated by penetration with a varying magnetic field.

Inductive heating is a process of heating an electrically conducting object (such as a susceptor) by electromagnetic induction. A magnetic field generator may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

In the present example, the susceptor plug 4 is located adjacent the aerosol-generating section 3 of the article 1. In use, air can pass from the external atmosphere through the fluid-permeable susceptor plug 4 to the aerosol-generating section 3. The susceptor plug 4 is in direct contact with aerosol-generating material in the aerosol-generating section 3. In use, this may improve the rate of heat transfer from the susceptor plug 4 to the aerosol-generating material 3 because heat can be readily transferred by conduction. In other embodiments, the susceptor plug 4 is separate from the aerosol-generating section 3. For example, the susceptor plug 4 may be offset with respect to the aerosol-generating section such that there is a gap or void between these two components. This may facilitate heat transfer by convection from the susceptor plug 4 to the aerosol-generating material and reduce or eliminate combustion of the aerosol-generating material during use. Alternatively, in such embodiments, the gap of void may be filled with a material that conducts heat. This may facilitate transfer of heat generated by the susceptor plug to the aerosol-generating material in the aerosol-generating section 3.

In some embodiments, the aerosol-generating section may have a cross sectional shape that is substantially the same as the cross sectional shape of the fluid-permeable susceptor plug. In some embodiments, this is advantageous because all of the air will pass through the susceptor plug, and thus be heated, before contacting the aerosol-generating material. This may improve the rate of aerosol-generation and thus the sensory experience for the user.

The porous susceptor plug 4 may have a diameter that is substantially the same as a diameter of the aerosol-generating section 3.

The porous susceptor plug may have a pressure drop of from about 0.001 mmWg/mm to about 20 mmWg/mm.

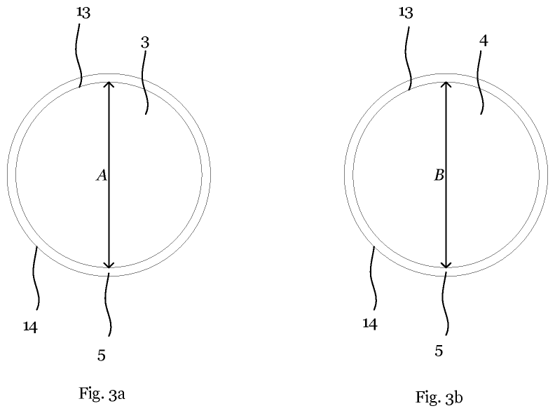

FIG. 3a depicts a cross-section through a portion of the aerosol-generating section 3 of the article 1, whilst FIG. 3b depicts a cross-section through a portion of the fluid-permeable susceptor plug 4 of the article 1.

Referring to FIG. 3a, the aerosol-generating section 3 comprises aerosol-generating material 3, wrapper 5 having an inwardly facing surface 13 and an outwardly facing surface 14.

The longest straight-line distance perpendicular to the longitudinal axis X-X′ of the article 1 depicted in FIG. 2 between a first portion of the inwardly facing surface 13 of the wrapper 5 and a second portion of the inwardly facing surface 13 of the wrapper 5 through the aerosol-generating section 3 is defined by distance A.

Referring to FIG. 3b, the fluid permeable susceptor plug 4 comprises a wrapper 5 having an inwardly facing surface 13 and an outwardly facing surface 14.

The longest straight-line distance perpendicular to the longitudinal axis X-X′ of the article 1 depicted in FIG. 2 between a third portion of the inwardly facing surface 13 of the wrapper 5 and a fourth portion of the inwardly facing surface 13 of the wrapper 5 is defined by distance B.

In some embodiments, distances A and B are substantially the same. In some embodiments, distance A is less than distance B. Thus, in some embodiments, the aerosol-generating section has a cross-sectional area that is substantially the same as, or less than, a cross-sectional area of the porous plug.

Where the article comprises two or more aerosol-generating sections, the aerosol-generating sections may comprise different aerosol-generating materials. Any combination of aerosol-generating materials may be used in the first and the second aerosol-generating sections.

The susceptor plug may be positioned anywhere in the aerosol-generating section.

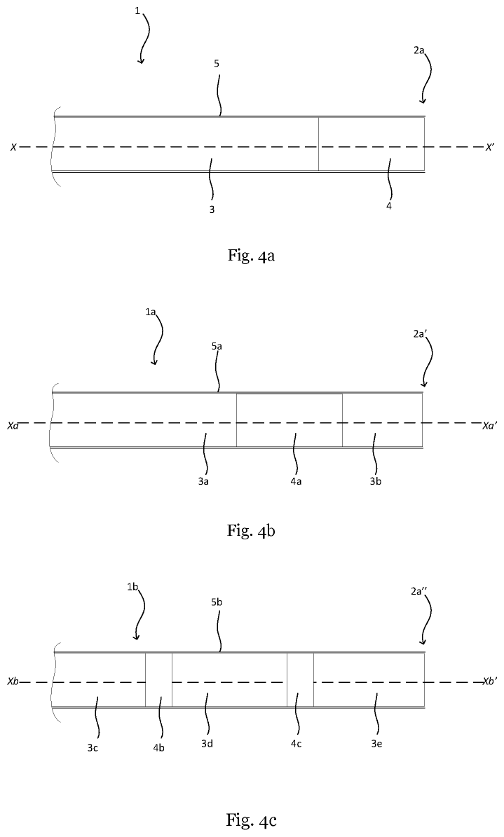

FIGS. 4a, 4b and 4c are side-on cross-sectional views of parts of articles for use with a non-combustible aerosol provision device.

Referring to FIG. 4a, the article 1 comprises the aerosol-generating material 3 and the fluid permeable susceptor plug 4 bounded by the wrapper 5. The wrapper has an inwardly facing surface that faces the aerosol-generating material and the fluid-permeable susceptor plug an outwardly facing surface that faces away from the aerosol-generating material. The article has a longitudinal axis, X-X′.

In the illustrated embodiment, aerosol-generating section 3 comprises a single susceptor plug 4 positioned at the upstream end 2a of the article 1. In use, the susceptor plug 4 is inductively heated by a varying magnetic field. The aerosol-generating material is heated in the aerosol-generating section 3 by the heat generated by the susceptor plug 4 and generates an aerosol. A user draws on the mouth end (not shown) of the article 1, which causes air to pass into the article 1 via the porous susceptor plug 4 and generated aerosol to be transferred to the user's mouth. Positioning the susceptor plug 4 at the upstream end 2a of the article 1 enables the gradual production of aerosol as the heat is conducted downstream along the length of the aerosol-generating section 3.

In some embodiments, article comprises more than one aerosol-generating section (for example, two or more aerosol-generating sections). The aerosol-generating sections may be separated by one or more fluid permeable susceptor plugs.

Referring to FIG. 4b, an article 1a comprises two aerosol-generating sections, namely a first aerosol-generating section 3a and a second aerosol-generating section 3b separated by a fluid permeable susceptor plug 4a. This arrangement may allow for the more rapid production of an aerosol because, relative to the embodiment illustrated in FIG. 3a, a greater proportion of the surface area of the susceptor plug 4a is in contact with the aerosol-generating material.

In the illustrated embodiment, the aerosol-generating sections 3a, 3b are different sizes and thus comprise different masses of aerosol-generating material. The first aerosol-generating section 3a may have a lower mass than the second aerosol-generating section, 3b. This arrangement may allow for rapid aerosol generation and a sustained delivery of aerosol over a session because the lower-mass first aerosol-generating section 3a may generate aerosol more quickly than the second section, 3b. The second section 3b may heat more slowly than the first section 3a and thus generate aerosol for a longer period of time and after aerosol-generation from the first section 3b has been exhausted. In other embodiments, the aerosol-generating sections can comprise identical masses of aerosol-generating material.

Referring to FIG. 4c, an article 1b comprises three aerosol-generating sections, namely a first aerosol-generating section 3c, a second aerosol-generating section 3d and a third aerosol-generating section 3e. A first fluid permeable susceptor 4b separates the first and the second aerosol-generating sections 3c, 3d. A second fluid permeable susceptor 4c separates the second and the third aerosol-generating sections. 3d, 3e.

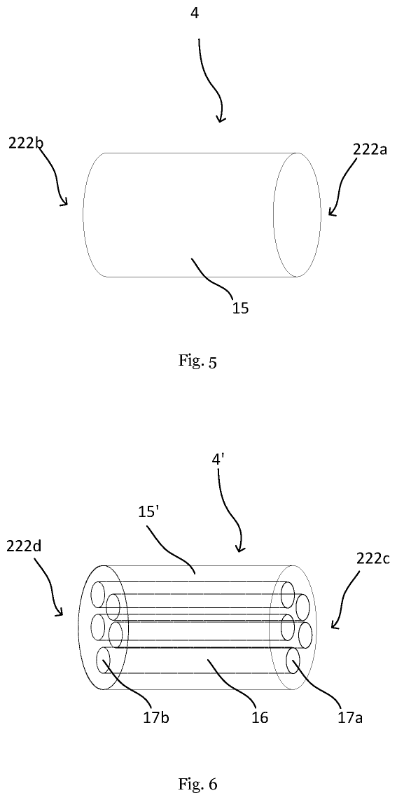

FIG. 5 is a perspective view of the fluid permeable susceptor plug 4. The susceptor plug 4 comprises a body 15 made from a susceptor material. The body 15 is cylindrical and can be made from any material that is heatable by a varying magnetic field such as a metal, or carbon. In some embodiments, the body 15 is made from stainless steel or carbon fiber. In the illustrated embodiment, the body is made from aluminium. The fluid permeable susceptor plug 4 comprises an upstream end 2a and a downstream end 2b. In other embodiments, the body 15 can be disc-shaped.

The fluid permeable susceptor plug 4 is permeable to fluid, which can be a liquid, a gas or a gas/liquid mixture, which may be an aerosol. In some embodiments, the fluid is air or a mixture of air and an aerosol, which may be generated by the aerosol-generating material as it is heated by the susceptor. Fluid may move through the body 15 between the upstream end 222a and the downstream end 222b.

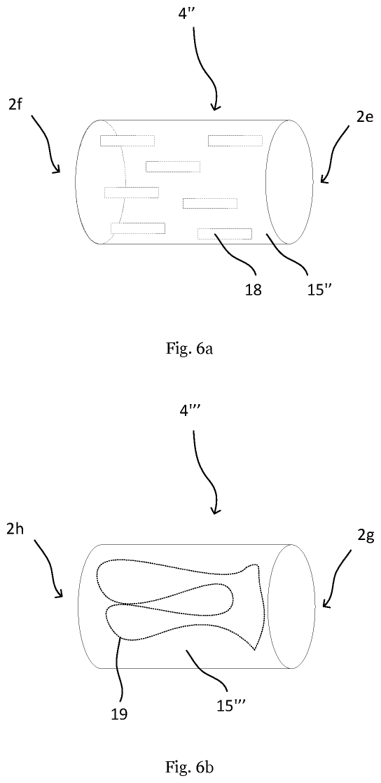

FIG. 6 is a perspective view of a susceptor plug 4′ comprises a plurality of channels 16 having open ends 21a at the upstream end 2a of the susceptor plug 4′ and open ends at the downstream end 2b and extending between the upstream end 2a and the downstream end 2b the body 15′. The channels 16 allow fluid, such as air and/or aerosol, to pass between the upstream end 222c and the downstream end 222d via channels 16 through the body 15′. Any number of channels 16 may be provided. The channels may be formed by drilling through the body 15′.

In some embodiments, the susceptor plug is porous. For example, the susceptor plug may be made from a susceptor material that is porous in nature, such as a web of metal fibers (for example, a compressed plug of wire wool, wherein the wire is metal). In some embodiments, the susceptor plug comprises a first material that is porous and made from a non-susceptor material and a second, non-porous, material that is a susceptor material.

FIG. 6a is a perspective view of a fluid-permeable susceptor plug 4″ comprising a body 15″ formed from a first material and a second material in the form of a plurality of discrete portions 18 made from a susceptor material and distributed throughout the first material of the body 15″. The discrete portions may be at least partially embedded in the first material. The susceptor material may be in the form of beads, flakes, particles, shards, rods, tubes or loops, for example. The discrete portions 18 may be distributed homogeneously throughout the material of the body 15″.

The first material is a material that may not be heatable by penetration with a varying magnetic field. This material may be one that can withstand the temperatures to which the article will be subjected to during use. For example, the material can be a ceramic, glass or plastic (e.g. a thermoplastic, such as polyether ether ketone (PEEK)). The susceptor material is in intimate contact with the material that is not heatable by penetration with a varying magnetic field. For example, the susceptor material can be at least partially embedded in the material that is not heatable by penetration with a varying magnetic field.

In an alternative embodiment, the second material may be in the form of a single portion (e.g. a mass, rod, loop, particle, granule or filament) of susceptor material. For example, the second material may be in the form of a single continuous rod embedded in the first material and which extends at least partially between the proximal end and the distal end of the porous plug.

FIG. 6b is a perspective view of a susceptor plug 4′″ comprises a body 4′″ made from a first material and a second material 19, which is made from metal thread, in the form of a continuous loop that is embedded in the first material 15′″. The first material is porous and arranged to allow fluid to pass from an upstream end 2g to a downstream end 2h.

The susceptor plug may be manufactured by any suitable means.

The susceptor plug may be made by machining or otherwise forming a body of material comprising a material heatable by penetration with a varying magnetic field to have the desired dimensions of the susceptor plug and then drilling channels into the body to provide passages through which a fluid may pass.

The susceptor plug may be formed from a metallic or non-metallic body of material. For example, the body of material may be formed from copper (including copper alloys), brass, aluminium, iron, steel (including stainless steel), tungsten, chrome, nickel (including nickel alloys), cobalt, carbon fiber, graphite, silicon, platinum, silver or gold, or mixtures of any of these.

In another example, the susceptor plug may be made by mixing a material its molten state, such as a thermoplastic (e.g. PEEK) with the susceptor material and then setting the susceptor plug in a mold of the desired dimensions to form the solid susceptor plug. Channels can then be formed in the solid susceptor plug by drilling to form the fluid-permeable susceptor plug.

In another example, the susceptor plug may be made by sintering a susceptor material (e.g. a metallic powder) into the desired shape of the susceptor plug.

In another example, the susceptor plug may be made by sintering a mixture comprising a non-susceptor material, such as ceramic powder, and a susceptor material to from a ceramic susceptor plug. The ceramic powder may be pressed or molded into the ultimate shape of the susceptor plug before the powder is sintered. In an example, the appropriate amount of susceptor material may be added and mixed to a portion of the ceramic powder. The mixture can then be formed and sintered. The sintering process allows the susceptor plug to be porous and fluid permeable.

Referring again to FIG. 2, the aerosol-generating section 3 comprises an aerosol-generating material.

An aerosol-generating material is a material that is capable of generating aerosol, for example when heated, irradiated or energized in any other way. The aerosol-generating material may be in the form of a solid, liquid, or semi-solid, such as a gel and may or may not contain an active substance and/or flavorants.

The aerosol-generating section 3 may comprise a plurality of aerosol-generating materials. The aerosol-generating materials may be the same as each other or different to each other. For example, the aerosol-generating composition may comprise a first aerosol-generating material and a second aerosol-generating material. Further (for example, third, fourth, fifth or more) aerosol-generating materials may also be included in the composition.

At least one of the aerosol-generating materials may comprise a binder (which may be a gelling agent) and an aerosol former. Optionally, an active and/or filler may also be present. Optionally, a solvent, such as water, is also present and one or more other components of the aerosol-generating material may or may not be soluble in the solvent.

In some embodiments, the binder comprises or is a gelling agent. The binder may comprise one or more compounds selected from the group comprising alginates, pectins, starches (and derivatives), celluloses (and derivatives), gums, silica or silicones compounds, clays, polyvinyl alcohol and combinations thereof. For example, in some embodiments, the binder comprises one or more of alginates, pectins, hydroxyethyl cellulose, hydroxypropyl cellulose, carboxymethylcellulose, pullulan, xanthan gum, guar gum, carrageenan, agarose, acacia gum, fumed silica, PDMS, sodium silicate, kaolin and polyvinyl alcohol. In some embodiments, the binder comprises a hydrocolloid. In some cases, the binder comprises alginate and/or pectin, and may be combined with a setting agent (such as a calcium source) during formation of the aerosol-generating material. In some cases, the aerosol-generating material may comprise a calcium-crosslinked alginate and/or a calcium-crosslinked pectin. The binder may comprise one or more compounds selected from cellulosic binders, non-cellulosic binders, guar gum, acacia gum and mixtures thereof.

In some embodiments, the cellulosic binder is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the binder comprises (or is) one or more of hydroxyethyl cellulose, hydroxypropyl cellulose, hydroxypropyl methylcellulose (HPMC), carboxymethylcellulose, guar gum, or acacia gum.

In some embodiments, the binder comprises (or is) one or more non-cellulosic binders, including, but not limited to, agar, xanthan gum, gum Arabic, guar gum, locust bean gum, pectin, carrageenan, starch, alginate, and combinations thereof. In preferred embodiments, the non-cellulose based binder is alginate or agar.

In some examples, aerosol-generating material comprises the binder in an amount of from about 5 to 40 wt % of the aerosol-generating material, or 15 to 40 wt %. That is, the aerosol-generating material comprises the binder in an amount of about 5 to 40 wt % by dry weight of the aerosol-generating material, or 15 to 40 wt %. In some examples, the aerosol-generating material comprises the binder in an amount of from about 20 to 40 wt %, or about 15 wt % to 35 wt % of the aerosol-generating material.

In some examples, alginate is comprised in the binder in an amount of from about 5 to 40 wt % of the aerosol-generating material, or 15 to 40 wt %. That is, the aerosol-generating material comprises alginate in an amount of about 5 to 40 wt % by dry weight of the aerosol-generating material, or 15 to 40 wt %. In some examples, the aerosol-generating material comprises alginate in an amount of from about 20 to 40 wt %, or about 15 wt % to 35 wt % of the aerosol-generating material.

In some examples, pectin is comprised in the binder in an amount of from about 3 to 15 wt % of the aerosol-generating material. That is, the aerosol-generating material comprises pectin in an amount of from about 3 to 15 wt % by dry weight of the aerosol-generating material. In some examples, the aerosol-generating material comprises pectin in an amount of from about 5 to 10 wt % of the aerosol-generating material.

In some examples, guar gum is comprised in the binder in an amount of from about 3 to 40 wt % of the aerosol-generating material. That is, the aerosol-generating material comprises guar gum in an amount of from about 3 to 40 wt % by dry weight of the aerosol-generating material. In some examples, the aerosol-generating material comprises guar gum in an amount of from about 5 to 10 wt % of the aerosol-generating material. In some examples, the aerosol-generating material comprises guar gum in an amount of from about 15 to 40 wt % of the aerosol-generating material, or from about 20 to 40 wt %, or from about 15 to 35 wt %.

In examples, the alginate is present in an amount of at least about 50 wt % of the binder. In examples, the aerosol-generating material comprises alginate and pectin, and the ratio of the alginate to the pectin is from 1:1 to 10:1. The ratio of the alginate to the pectin is typically >1:1, i.e. the alginate is present in an amount greater than the amount of pectin. In examples, the ratio of alginate to pectin is from about 2:1 to 8:1, or about 3:1 to 6:1, or is approximately 4:1.

The aerosol-generating material may be formed by forming a slurry, which is then dried to form a solid. The inclusion of a binder in the slurry results in the aerosol-generating material being formed from a dried gel. It has been found that, by including a binder in the aerosol-generating material, flavorant compounds, for example, menthol, are stabilised within the gel matrix allowing a higher flavorant loading to be achieved than in non-gel compositions. The flavoring (e.g. menthol) is stabilised at high concentrations and the products have a good shelf life.

In some embodiments, the binder comprises alginate, and the binder is present in the aerosol-generating material in an amount of from 10-30 wt %, 20-35 wt % or 25-30 wt % of the slurry/aerosol-generating material (calculated on a dry weight basis). In some embodiments, alginate is the only binder present in the aerosol-generating material. In other embodiments, the binder comprises alginate and at least one further binder, such as pectin.

The aerosol-generating material may comprise an aerosol former. An “aerosol former” (also referred to herein as an aerosol former material) is an agent that promotes the generation of an aerosol. An aerosol former may promote the generation of an aerosol by promoting an initial vaporization and/or the condensation of a gas to an inhalable solid and/or liquid aerosol. In some embodiments, an aerosol former may improve the delivery of flavor from the aerosol generating material. In general, any suitable aerosol former or agents may be included in the aerosol generating material of the invention, including those described herein. Other suitable aerosol formers include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate.

The aerosol former may be included in the aerosol-generating material in an amount of up to about 80 wt % of the aerosol-generating material, such as from about 0.1 wt %, 0.5 wt %, 1 wt %, 3 wt %, 5 wt %, 7 wt % or 10% to about 80 wt %, 75 wt %, 70 wt %, 65 wt %, 60 wt %, 55 wt %, 50 wt %, 45 wt %, 40 wt %, 35 wt %, 30 wt % or 25 wt % of an aerosol former material. In some embodiments, the aerosol-generating material comprises an aerosol former in an amount of about 40 to 80 wt %, 40 to 75 wt %, 50 to 70 wt %, or 55 to 65 wt %.

In some embodiments, the aerosol former is glycerol, propylene glycol, or a mixture of glycerol and propylene glycol. Glycerol may be present in an amount of from 10 to 20% by weight of the tobacco material, for example 13 to 16% by weight of the composition, or about 14% or 15% by weight of the composition. Propylene glycol, if present, may be present in an amount of from 0.1 to 0.3% by weight of the composition.

The aerosol former material may act as a plasticiser. In some cases, the aerosol former material comprises one or more compound selected from erythritol, propylene glycol, glycerol, triacetin, sorbitol and xylitol. In some cases, the aerosol former material comprises, consists essentially of, or consists of glycerol. It has been established that if the content of the plasticiser is too high, the aerosol-generating material may absorb water resulting in a material that does not create an appropriate consumption experience in use. It has been established that if the plasticiser content is too low, the aerosol-generating material may be brittle and easily broken. The plasticiser content specified herein provides an aerosol-generating material flexibility which allows the sheet to be wound onto a bobbin, which is useful in manufacture of consumables or can allow the sheet to be transported prior to shredding.

The aerosol former may enhance the mouthfeel, as well as the organoleptic properties in general, of the aerosol produced by the aerosol-generating material when heated and inhaled by a user, particularly where the aerosol-generating material comprises relatively high quantities (e.g. >40 wt %) of aerosol former. The capability of aerosol-generating materials to retain high quantities of aerosol former may reduce the need for other components of the aerosol-generating material, such as the expanded botanical material, to be loaded with high quantities of aerosol former. This may improve manufacturing efficiency.

The aerosol-generating material may comprise a filler. The filler is generally a non-tobacco component, that is, a component that does not include ingredients originating from tobacco.

The filler component may be a non-tobacco fiber such as wood fiber or pulp or wheat fiber.

The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent.

In some cases, the aerosol-generating material comprises 5-50 wt %, 10-40 wt % or 15-30 wt % of the filler. In some such cases the aerosol-generating material comprises at least 1 wt % of the filler, for example, at least 5 wt %, at least 10 wt %, at least 20 wt % at least 30 wt %, at least 40 wt %, or at least 50 wt % of a filler. In exemplary embodiments the aerosol-generating material comprises from 5-25 wt % of a filler comprising fibers. Suitably the filler consists of fibers, or is in the form of fibers.

In some embodiments, the aerosol-generating material comprises less than 60 wt % of the filler, such as from 1 wt % to 60 wt %, or 5 wt % to 50 wt %, or 5 wt % to 30 wt %, or 10 wt % to 20 wt %.

In other embodiments, the aerosol-generating material comprises less than 20 wt %, suitably less than 10 wt % or less than 5 wt % of the filler.

The filler may comprise one or more organic filler materials such as wood pulp, cellulose and cellulose derivatives (such as methylcellulose, hydroxypropyl cellulose, and carboxymethyl cellulose (CMC)). An inorganic filler, such as calcium carbonate or chalk may be used. In some embodiments, the aerosol-generating material comprises no calcium carbonate such as chalk.

Suitably, the filler is fibrous. For example, the filler may be a fibrous organic filler material such as wood pulp, hemp fiber, cellulose or cellulose derivatives (such as methylcellulose, hydroxypropyl cellulose, and carboxymethyl cellulose (CMC)). Without wishing to be bound by theory, it is believed that including fibrous filler in an aerosol-generating material may increase the tensile strength of the material. Additionally, including a fibrous filler has been found to improve the handling of the aerosol-generating material during manufacturing. In particular, it has been found that the resulting aerosol-generating material is less “tacky” and consequently is easier to shred during manufacturing. Including a fibrous filler can therefore increase manufacturing efficiency, reducing the likelihood of machine stops during shredding. Including a fibrous filler in the aerosol-generating material also means that the aerosol-generating material is less likely to clump together (e.g. agglomerate) once it has been shredded. When the shredded aerosol-generating material is included in consumables, reduced agglomeration optimises the distribution of the shredded aerosol-generating material in the consumables. It is therefore more likely that each consumable will contain a similar quantity of shredded aerosol-generating material, which may improve homogeneity of the flavorant loading within batches of consumables and/or within a given consumable.

The aerosol-generating material may be prepared by forming a slurry comprising components of the aerosol-generating material or precursors thereof, forming a layer of the slurry, setting the slurry to form a gel and drying to form the aerosol-generating material. Optionally, the setting the slurry at step comprises applying a setting agent to the slurry. In some embodiments, a setting agent is sprayed on the slurry, such as a top surface of the slurry.

In some embodiments, the setting agent comprises or consists of calcium acetate, calcium formate, calcium carbonate, calcium hydrogencarbonate, calcium chloride, calcium lactate, or a combination thereof. In some embodiments, the setting agent comprises or consists of calcium formate and/or calcium lactate. In particular embodiments, the setting agent comprises or consists of calcium formate. It has been identified that, typically, employing calcium formate as a setting agent results in an aerosol-generating material having a greater tensile strength and greater resistance to elongation.

The total amount of the setting agent, such as a calcium source, may be 0.5-5 wt % (calculated on a dry weight basis). Suitably, the total amount may be from about 1 wt %, 2.5 wt % or 4 wt % to about 4.8 wt % or 4.5 wt %. It has been found that the addition of too little setting agent may result in an aerosol-generating material which does not stabilise the aerosol-generating material components and results in these components dropping out of the aerosol-generating material. It has been found that the addition of too much setting agent results in an aerosol-generating material that is very tacky and consequently has poor handleability.

When the aerosol-generating material does not contain tobacco, a higher amount of setting agent may need to be applied. In some cases the total amount of setting agent may therefore be from 0.5-12 wt % such as 5-10 wt %, calculated on a dry weight basis. Suitably, the total amount may be from about 5 wt %, 6 wt % or 7 wt % to about 12 wt % or 10 wt %. In this case the aerosol-generating material will not generally contain any tobacco.

The process comprises forming a layer of the slurry. This typically comprises spraying, casting or extruding the slurry. In examples, the slurry layer is formed by electrospraying the slurry. In examples, the slurry layer is formed by casting the slurry.

In some examples, all of the steps of the process, at least partially, occur simultaneously (for example, during electrospraying). In some examples, the steps of the process occur sequentially.

In some embodiments, the aerosol-generating material comprises a substance to be delivered.

The substance to be delivered may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives (including, where appropriate but not limited to, the corresponding acid forms of these materials), or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like.

Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco material.

In some embodiments, the botanical material is tobacco. Thus, in some embodiments, the aerosol-generating material comprises tobacco.

As used herein, the term “tobacco material” refers to a material derived from a plant of the Nicotiana species. The selection of the plant of the Nicotiana species is not limited, and the types of tobacco or tobaccos used may vary. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, leaf tobacco, tobacco stem, reconstituted tobacco and/or tobacco extract. As used herein, “leaf tobacco” means cut lamina tobacco.

In some embodiments, the tobacco material is selected from flue-cured or Virginia, Burley, sun-cured, Maryland, dark-fired, dark air cured, light air cured, Indian air cured, Red Russian and Rustica tobaccos, and mixtures thereof, as well as various other rare or specialty tobaccos, green or cured. Tobacco material produced via any other type of tobacco treatment which could modify the tobacco taste, such as fermented tobacco or genetic modification or crossbreeding techniques, is also within the scope of the present disclosure. For example, it is envisaged that tobacco plants may be genetically engineered or crossbred to increase or decrease production of components, characteristics or attributes.

In some embodiments, the tobacco material is sun-cured tobacco, selected from Indian Kurnool and Oriental tobaccos, including Izmir, Basma, Samsun, Katerini, Prelip, Komotini, Xanthi and Yambol tobaccos. In some embodiments, the tobacco material is dark air cured tobacco, selected from Passanda, Cubano, Jatin and Besuki tobaccos. In some embodiments, the tobacco material is light air cured tobacco, selected from North Wisconsin and Galpao tobaccos.

In some embodiments, the tobacco material is selected from Brazilian tobaccos, including Mata Fina and Bahia tobaccos. In some embodiments, the tobacco material is selected from criollo, Piloto Cubano, Olor, Green River, Isabela DAC, White Pata, Eluru, Jatim, Madura, Kasturi, Connecticut Seed, Broad Leaf, Connecticut, Pennsylvanian, Italian dry air cured, Paraguayan dry air cured and One Sucker tobaccos.

For the preparation of smoking/vaping or smokeless tobacco products, plants of the Nicotiana species may be subjected to a curing process. Certain types of tobaccos may be subjected to alternative types of curing processes, such as fire curing or sun curing. Preferably, but not necessarily, harvested tobaccos that are cured are aged.

The tobacco can be harvested in different stages of growth, for example when the plant is has reached a level of maturity and the lower leaves are ready for harvest whilst the upper leaves are still in development.

In some embodiments, at least one portion of the plant of the Nicotiana species (e.g., at least a portion of the tobacco material) is employed in an immature form. That is, in some embodiments, the plant, or at least one portion of that plant, is harvested before reaching a stage normally regarded as ripe or mature.

In some embodiments, at least a portion of the plant of the Nicotiana species (e.g. at least a portion of the tobacco material) is employed in a mature form. That is, in some embodiments, the plant, or at least one portion of that plant, is harvested when that plant (or plant portion) reaches a point that is traditionally viewed as being ripe, over-ripe or mature, which can be accomplished through the use of tobacco harvesting techniques conventionally employed by farmers. Both Oriental tobacco and Burley tobacco plants can be harvested. Also, the Virginia tobacco leaves can be harvested or primed depending upon their stalk position.

The Nicotiana species may be selected for the content of various compounds that are present in the plant. For example, plants may be selected on the basis that those plants produce relatively high quantities of one or more of the compounds desired to be isolated (i.e. the volatile compounds of interest). In certain embodiments, plants of the Nicotiana species are specifically cultivated for their abundance of leaf surface compounds. Tobacco plants may be grown in green-houses, growth chambers, or outdoors in fields, or grown hydroponically.

Various parts or portions of the plant of the Nicotiana species may be utilized. In some embodiments, the whole plant, or substantially the whole plant, is harvested and employed as such. As used herein, the term “substantially the whole plant” means that at least 90% of the plant is harvested, such as at least 95% of the plant, such as at least 99% of the plant. Alternatively, in some embodiments, various parts or pieces of the plant are harvested or separated for further use after harvest. In some embodiments, the tobacco material is selected from the leaves, stems, stalks of the plant, and various combinations of these parts. The tobacco material of the disclosure may thus comprise an entire plant or any portion of a plant of the Nicotiana species.

The tobacco material may comprise or consist of reconstituted tobacco, tobacco lamina, paper reconstituted tobacco, extruded tobacco, bandcast reconstituted tobacco, or a combination of reconstituted tobacco and another form of tobacco, such as tobacco lamina or granules.

In some embodiments, the aerosol-generating material is substantially free from botanical material. In particular, in some embodiments, the aerosol-generating material is substantially tobacco free.

In some embodiments, the active substance comprises or is derived from one or more botanicals or constituents, derivatives or extracts thereof and the botanical is selected from eucalyptus, star anise, cocoa and hemp.

In some embodiments, the active substance comprises or is derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the aerosol-generating material may comprise up to about 80 wt %, 70 wt %, 60 wt %, 55 wt %, 50 wt % or 45 wt % of flavorant. In some cases, the aerosol-generating material may comprise at least about 0.1 wt %, 1 wt %, 10 wt %, 20 wt %, 30 wt %, 35 wt % or 40 wt % of flavorant (all calculated on a dry weight basis). For example, the aerosol-generating material may comprise 1-80 wt %, 10-80 wt %, 20-70 wt %, 30-60 wt %, 35-55 wt % or 30-45 wt % of flavorant. In exemplary embodiments, the aerosol-generating material comprises 35-50 wt % of flavorant. In some cases, the flavorant comprises, consists essentially of or consists of menthol.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-generating section may comprise an aerosol generating material in the form of an “amorphous solid”. The aerosol-generating material may be a “monolithic solid”. In some embodiments, the aerosol-generating material may be a dried gel.

The aerosol-generating section may comprise an aerosol generating material in the form of an aerosol-generating film. The aerosol-generating film may be formed by combining a binder, such as a gelling agent, with a solvent, such as water, an aerosol-former and one or more other components, such as active substances, to form a slurry and then heating the slurry to volatilize at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating material may comprise or be a sheet, which may optionally be shredded to form a shredded sheet. The sheet of aerosolizable material may be cut lengthwise and/or width-wise, for example in a cross-cut type shredding process, to define a cut length for the strands or strips of aerosolizable material, in addition to a cut width.

The aerosol-generating section may comprise any combination of the above aerosol-generating materials. For example, the aerosol-generating composition may comprise a blend of aerosol-generating materials, at least one of which comprises a binder and an aerosol-former. In some embodiments, the aerosol-generating section comprises (e.g. a first) aerosol-generating material comprising a binder and an aerosol former and (e.g. a second) different aerosol-generating material. For example, the second aerosol-generating material may be a botanical material, such as tobacco lamina.

The aerosol-generating material may comprise 1 to 60 wt % of a gelling agent, 0.1 to 70 wt % of an aerosol former material, 5 to 50% of filler in the form of fibers, and 0.1 to 80 wt % of a flavorant and/or active substance.

The aerosol-generating material may comprise 10 to 40 wt % gelling agent, 10 to 70 wt % of an aerosol former material, 20 to 40 wt % of filler and optionally 10 to 50 wt % of a flavorant.

In an embodiment, the aerosol-generating material comprises alginate in an amount of 32.8 w %, glycerol in an amount of 19.2 wt % and menthol in an amount of 48 wt %.

In an embodiment, the aerosol-generating material comprises alginate in amount of 26.2 wt %, glycerol in an amount of 15.4 wt %, menthol in an amount of 38.4 wt % and fibers (from wood pulp) in an amount of 20 wt %.

In an embodiment, the aerosol-generating material comprises alginate in an amount of 32 wt %, pectin in an amount of 8 wt % and glycerol in an amount of 60 wt %.

In an embodiment, the aerosol-generating material comprises alginate in an amount of 24 wt %, pectin in an amount of 6 wt %, cellulose fibers in an amount of 10 wt % and glycerol in an amount of 60 wt %.

In an embodiment, the aerosol-generating material comprises carboxymethyl cellulose (CMC) in an amount of about 7 wt %, cellulose fibers (from wood pulp) in an amount of about 43 wt % and glycerol in an amount of about 50 wt %.

The articles disclosed herein are is suitable for use with a non-combustible aerosol provision device.

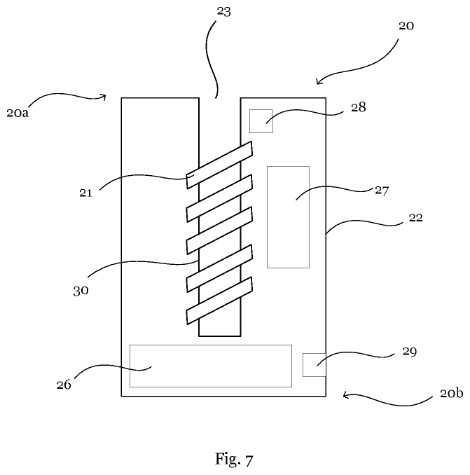

FIG. 7 shows a schematic view of an example of a non-combustible aerosol provision device 20 having a proximal end 20a and a distal end 20b.

In broad outline, the device 20 may be used to cause an article (not shown) comprising a fluid-permeable susceptor plug and aerosol generating material, for instance an article described herein, to generate an aerosol which is inhaled by a user of the device 20.

The device 20 and the article together form a system.

The device 20 comprises a magnetic field generator comprising a coil 21 configured to generate varying magnetic field. The varying magnetic field causes the susceptor plug in the article to generate heat which, in turn, heats the generating aerosol to form an aerosol

The device 20 comprises a housing 22 which surrounds and houses various components of the device 20. The device 20 has an opening 23 in one end, through which the article 1 may be inserted. In use, the article 1 may be fully or partially inserted into the heating assembly.

The device 20 may also include a user-operable control element 28, such as a button or switch, which operates the device 20 when pressed. For example, a user may turn on the device 20 by operating the switch 28.

The device 20 may also comprise an electrical component, such as a socket/port 29, which can receive a cable to charge a power source 26 of the device 20. For example, the socket 29 may be a charging port, such as a USB charging port.

In use, a user inserts an article 1 into the opening 23, operates the user control 28 to begin heating the aerosol generating material and draws on the aerosol generated in the device. This causes the aerosol to flow through the device 20 along a flow path towards the proximal end 20a of the device 20.

The other end of the device furthest away from the opening 23 may be known as the distal end 20b of the device 20 because, in use, it is the end furthest away from the mouth of the user. As a user draws on the aerosol generated in the device, the aerosol flows away from the distal end of the device 20.

The power source 26 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the magnetic field genertor to supply electrical power when required and under control of a controller (not shown) to heat the aerosol generating material.

The device further comprises at least one electronics module 27. The electronics module 27 may comprise, for example, a printed circuit board (PCB). The PCB 27 may support at least one controller, such as a processor, and memory. The PCB 27 may also comprise one or more electrical tracks to electrically connect together various electronic components of the device 20. For example, battery terminals (not shown) may be electrically connected to the PCB 27 so that power can be distributed throughout the device 20. The socket 29 may also be electrically coupled to the battery via the electrical tracks.

The device 20 includes a magnetic field generator comprising a coil 21 that is configured to inductively heat a fluid-permeable susceptor plug in the article.

The coil 17 is an inductor coil. The inductor coil is made from an electrically conducting material. In this example, the inductor coil is made from Litz wire/cable which is wound in a helical fashion to provide a helical inductor coil. Litz wire comprises a plurality of individual wires which are individually insulated and are twisted together to form a single wire. Litz wires are designed to reduce the skin effect losses in a conductor. In the example device 20, the inductor coil is made copper and the Litz wire has a rectangular cross section.

In other examples the Litz wire can have other shape cross sections, such as circular.

The inductor coil 21 is configured to generate a first varying magnetic field for heating a susceptor an article. The inductor coil 21 can be connected to the PCB 27.

The device comprises inductor coil support tube 30. The coil support tube 30 is defined by an outer surface an inner surface. The outer surface of the coil support tube supports the inductor coil 21. The inner surface defines a cavity into which the article 1 can be inserted.

Tube 30 is preferably made from a material that is not heatable by penetration with a varying magnetic field. This is to avoid the inductor heating the tube during use and also to reduce power consumption.

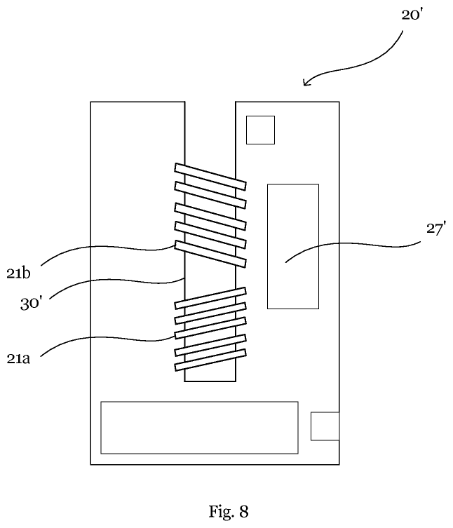

FIG. 8 shows a schematic view of a device 20′ comprising two magnetic field generators comprising a first inductor coil 21a and a second inductor coil 21b. The first inductor coil 21a is configured to generate a first varying magnetic field for heating a first susceptor plug in an article for use with a non-combustible aerosol provision device and the second inductor coil 21b is configured to generate a second varying magnetic field for heating a second susceptor plug in the article. In this example, the first inductor coil 21a is adjacent to the second inductor coil 21b in a direction along the longitudinal axis of the device 20′ (that is, the first and second inductor coils 21a, 21b to not overlap). The first and second inductor coils 21a, 21b can be connected to the PCB 27′. The first and second coils are supported by the coil support tube 30′.

It will be appreciated that the first and second inductor coils 21a, 21b, in some examples, may have at least one characteristic different from each other. For example, the first inductor coil 21a may have at least one characteristic different from the second inductor coil 21b. More specifically, in one example, the first inductor coil 21a may have a different value of inductance than the second inductor coil 21b. The first and second inductor coils 21a, 21b can be of different lengths. Thus, the first inductor coil 21a may comprise a different number of turns than the second inductor coil 21b (assuming that the spacing between individual turns is substantially the same). In yet another example, the first inductor coil 21a may be made from a different material to the second inductor coil 21b. In some examples, the first and second inductor coils 21a, 21b may be substantially identical.

In this example, the first inductor coil 21a and the second inductor coil 21b are wound in opposite directions. This can be useful when the inductor coils are active at different times.

For example, initially, the first inductor coil 21a may be operating to heat a first section/portion of the article 1, and at a later time, the second inductor coil 21b may be operating to heat a second section/portion of the article. Winding the coils in opposite directions helps reduce the current induced in the inactive coil when used in conjunction with a particular type of control circuit. In FIG. 8, the first inductor coil 21a is a right-hand helix and the second inductor coil 21b is a left-hand helix. However, in another embodiment, the inductor coils 21a, 21b may be wound in the same direction, or the first inductor coil 21a may be a left-hand helix and the second inductor coil 21b may be a right-hand helix.

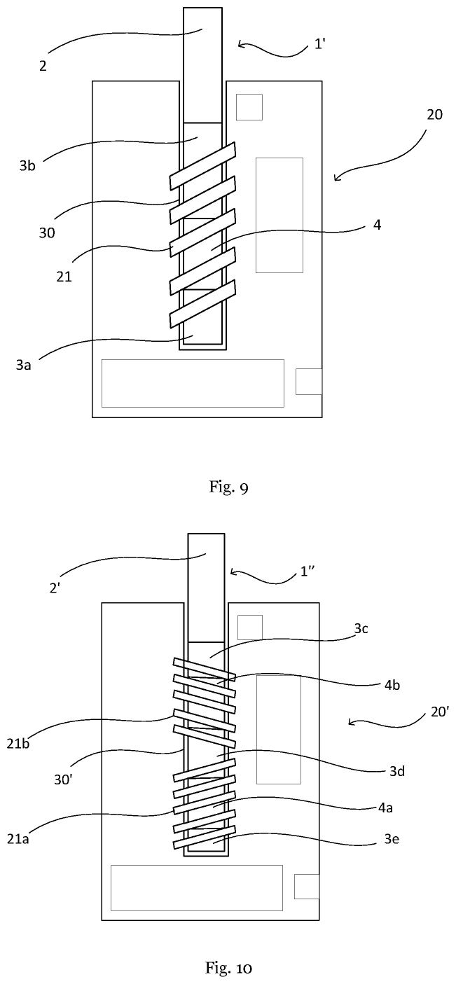

In use, an article described herein can be inserted into a non-combustible aerosol provision device such as the device 20 and 20′ described with reference to FIGS. 9 and 10. At least a portion of a mouthpiece 2, 2′ of the article 1, 1′ protrudes from the non-combustible aerosol provision device 20, 20′ and can be placed into a user's mouth.

Referring to FIG. 9, the magnetic field generator comprises a single coil 21. The magnetic field generator is configured to inductively heat the fluid-permeable susceptor plug 4. An aerosol is produced by inductively heating porous plug 4 the aerosol generating sections 3a, 3b comprising aerosol-generating material. The aerosol produced by the aerosol generating material passes through the mouthpiece 2 to the user's mouth.

The outer surface of the article 1 may be dimensioned so that the outer surface of the article 1 abuts the inner surface of the coil support tube 30. This ensures that the heating is most efficient because fluid permeable susceptor plug is closer to the coil 21.

FIG. 10 shows an article 1″ comprising first and second fluid permeable susceptor plugs 4a, 4b and aerosol-generating sections 3c, 3d, 3e. The article 1′ is received within the coil support tube 30′ of the device 20′. The magnetic field generator comprises two coils 21a and 21b. The fluid-permeable susceptor plugs are arranged such that they are in general alignment with the coils 21a, 21b when the article 1′ is received within the coil support tube 30′. This enables the fluid-permeable susceptor plugs to be heated at different times and/or to different temperatures be the coils 21a, 21b.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An article for use with a non-combustible aerosol-provision device, the article comprising at least one fluid-permeable susceptor plug.

2. An article as claimed in claim 1, wherein the article is in the form of a rod having a distal end and a mouth end opposite to the distal end.

3. An article as claimed in claim 1, wherein the article comprises an aerosol-generating section comprising aerosol-generating material.

4. An article as claimed in claim 3, wherein the fluid permeable susceptor plug is adjacent the aerosol-generating material.

5. An article as claimed in claim 3, wherein the article comprises two or more aerosol-generating sections, each section comprising aerosol-generating material.

6. An article as claimed in claim 5, wherein the fluid permeable susceptor plug is adjacent at least two of the two or more sections.

7. An article as claimed in claim 5, wherein the sections of aerosol-generating material are separated by one or more susceptor plugs.

8. An article as claimed in claim 3, wherein the aerosol-generating section and the porous plug are circumscribed by a wrapper.

9. An article as claimed in claim 2, wherein the susceptor plug is arranged to allow passage of gas from an environment external to the article from the distal end to the mouth end and through the susceptor plug in use.

10. An article as claimed in claim 2, wherein the susceptor plug is positioned at the distal end of the rod such that, in use, air flows through the susceptor plug before contacting at least one of the one or more aerosol-generating materials.

11. An article as claimed in claim 5, wherein the susceptor plug is positioned in the aerosol-generating section such that, in use, air flows through at least one of the sections of aerosol-generating material before flowing through the susceptor plug.

12. An article as claimed in claim 5, wherein the article comprises a first section of aerosol-generating material and a second section of aerosol-generating material and the susceptor plug is positioned in the article such that, in use, the first section of aerosol-generating material generates an aerosol when heated which flows through the susceptor plug before flowing through the second section of aerosol-generating material.

13. An article as claimed in claim 5, wherein the susceptor plug has a cross-sectional shape substantially identical to a cross-sectional shape of one or more of the one or more aerosol-generating sections.

14. An article as claimed in claim 1, wherein the susceptor plug is porous.

15. An article as claimed in claim 1, wherein the susceptor plug comprises a material heatable by penetration with a varying magnetic field in an amount of up to 100 wt %.

16. An article as claimed in claim 14, wherein the material heatable by penetration with a varying magnetic field is a metal or a non-metal.

17. An article as claimed in claim 15, wherein the material heatable by penetration with a varying magnetic field is in the form of beads, flakes, particles, shards, rods, tubes or loops.

18. An article as claimed in claim 1, wherein the susceptor plug comprises a fibrous material.

19. An article as claimed in claim 19, wherein the susceptor plug comprises a material that is not heatable by penetration with a varying magnetic field.

20. An article as claimed in claim 15, wherein the material heatable by penetration with a varying magnetic field is at least partially embedded in the material that is not heatable by penetration with a varying magnetic field.

21. An article as claimed in claim 19, wherein the material not heatable by penetration with a varying magnetic field is selected from the group consisting of: ceramic, plastic, botanical material, glass and a mineral.

22. An article as claimed in claim 3, wherein the aerosol-generating material comprises botanical material.

23. An article as claimed in claim 3, wherein the aerosol-generating material comprises reconstituted tobacco and/or lamina tobacco.

24. A fluid-permeable susceptor plug for use in the article as claimed in claim 1.

25. A device for use with the article as claimed in claim 1, wherein the device comprises a magnetic field generator configured to generate varying magnetic field.

26. A system comprising an article as claimed in claim 1, wherein the device comprises a magnetic field generator configured to generate varying magnetic field.

27. A use of an article as claimed in claim 1 with a non-combustible aerosol provision device to generate an aerosol.
